(19) United States
(12) Patent Application Publication
(10) Pub. No.: US 2025/0076252 A1
(43) Pub. Date: Mar. 6, 2025

(54) DELIVERY CONDUIT FOR EDDY CURRENT PROBES

(71) Applicant: Zetec Inc., Snoqualmie, WA (US)

(72) Inventors: Evan Lloyd, Fall City, WA (US); Wayne Rector, Bellevue, WA (US); Brooks McKinney, Bellevue, WA (US); William Frederick Ziegenhagen, Black Diamond, WA (US)

(21) Appl. No.: 18/817,492

(22) Filed: Aug. 28, 2024

Related U.S. Application Data
(60) Provisional application No. 63/579,636, filed on Aug. 30, 2023.

(51) Int. Cl. G01N 27/90; G01N 27/9013

(52) U.S. Cl. CPC G01N 27/9006; G01N 27/902

(57) ABSTRACT

An eddy current probe system includes a probe head, and a length of delivery tubing coupled to the probe head for pushing or pulling the probe head into or out of a conduit under test. The delivery tubing comprises an ultra high molecular weight (UHMW) polyethylene material sufficient to enable insertion of the probe head into a convoluted, lengthy, or damaged conduit under test.

### CROSS-REFERENCE TO RELATED APPLICATION

This application claims priority under 35 U.S.C. § 119, based on U.S. Provisional Patent Application No. 63/579,636 filed Aug. 30, 2023, titled “Delivery Conduit for Eddy Current Probes,” the disclosure of which is hereby incorporated by reference.

### BACKGROUND

Steam generation for driving turbines has been an aspect of electrical power generation for many decades. Routine monitoring of the condition of high-pressure steam tubes in steam generators is critical. Steam tube inspection is generally conducted with cylindrically shaped eddy current probes that are inserted into steam tube arrays. The eddy current probe travels through the arrays/tubes and emits eddy currents onto surfaces of the tubes. The tubes are attached to cabling while monitoring equipment records the eddy current response as the probe travels through the tubes.

Eddy current probes operate by using coils alternating an electromagnet field onto a conduit as it travels within the conduit and receiving electromagnetic returns via the conduit. The electromagnetic field produces eddy currents in the tubes, which can be measured either by a change in impedance of the excitation coil or by separate coils, hall-effect sensors or magneto-resistive sensors. In interacting with the conduit structure, the probe is able to locate defects by recognizing anomalies, such as disbonds, bubbles, cracks, corrosion, delaminations, thickness variation, and the like.

Typical eddy current probes for non-destructive testing of heat exchanger tubing and the like are composed of a probe head supporting a plurality of sensing coils and a flexible nylon delivery tubing which is used to push/pull the probe head into or out of the tubing or conduit under test, typically using a motorized or pneumatic tube or conduit pushing/pulling device. Wiring for the probe head is carried within the delivery tubing and a connector is typically provided for enabling a removable connection to testing equipment.

Unfortunately, as the length of the tubing under test is increased, as more bends, curves, or undulations are provided in the conduit under test, or when a conduit under test has undergone compression or ovalization, friction forces between the nylon delivery tubing and the inside surface of the tubing under test renders it increasingly difficult to deliver the eddy current probe to all sections of the conduit under test.

### BRIEF DESCRIPTION OF THE DRAWINGS

FIG. 1 is a perspective view of an eddy current probe and delivery conduit consistent with implementations described herein; and

FIG. 2 is a cross-sectional view of delivery tubing consistent with implementations described herein.

### DETAILED DESCRIPTION OF EMBODIMENTS

The following detailed description refers to the accompanying drawings. The same reference numbers in different drawings may identify the same or similar elements. Also, the following detailed description does not limit the invention.

Implementations described herein relate to non-destructive testing devices that include one or more testing coils for introducing an electromagnetic field into a tubular conduit under test. The non-destructive testing devices include a probe head coupled to a probe shaft. The shaft is coupled to a length of delivery tubing which is used to push or drive the probe head and probe shaft into the conduit under test or pull the probe head from the conduit. Consistent with implementations described herein, delivery tubing may include an ultra high molecular weight (UHMW) polyethylene material. Such a UHMW material has a low coefficient of friction and high abrasion resistance relative to traditional nylon (polyamide) delivery tubing, which allows for reduced force requirements when pushing the probe head and delivery tubing into a conduit under test. Consistent with implementations described herein, the UHMW delivery tubing may be forcibly pushed or withdrawn from the conduit under test by a mechanical or motorized tube or conduit pushing/pulling device.

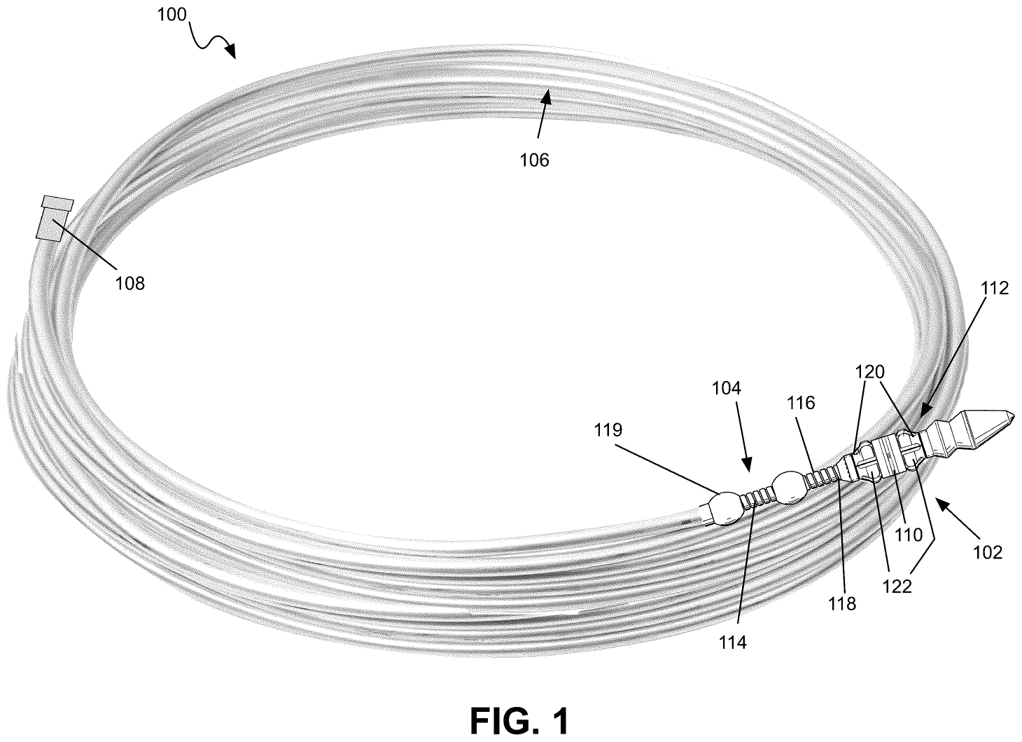

FIG. 1 is an isometric view of an eddy current probe system 100 consistent with implementations described herein. As shown, eddy current probe system 100 includes an eddy current probe head 102, a probe shaft 104, UHMW delivery tubing 106, and a probe connector 108. Probe head 102 includes a probe body 110 containing at least one eddy current generating coil that projects and detects an alternating electromagnetic field within a tube under test. In some implementations, probe head 102 may include one or more centering members 112 for ensuring that probe body 110 is centered within the conduit under test.

As shown, probe shaft 104 may include an extended flexible drive section 114, a rigid section 116 at its distal end 118 to which probe head 102 is attached, and a plurality of centering beads 119. Typically, probe body 110 is secured on distal end 118 between a pair of centering members 112 to maintain the probe body 110 centrally in a conduit under test. In one implementation, each probe centering member 112 includes a tubular or frustoconical base portion 120, from which a plurality of resilient cantilevered legs 122 project radially and distally outwardly therefrom and are coaxially spaced apart from base portion 120. Tubular base portion 120 and resilient cantilevered legs 122 form a central aperture configured to engage probe body 104 and/or distal end 118 of probe shaft 104.

Consistent with implementations described herein, UHMW delivery tubing 106 may be formed of a particular type of thermoplastic polyethylene that includes long chains of polyethylene molecules and a molecular mass of between, for example, 3.5 and 7.5 atomic mass units. In addition, the UHMW material of delivery tubing 106 may have an impact strength of approximately 16.8 ft.-lbs./in. and a durometer rating of approximately 65D-67D.

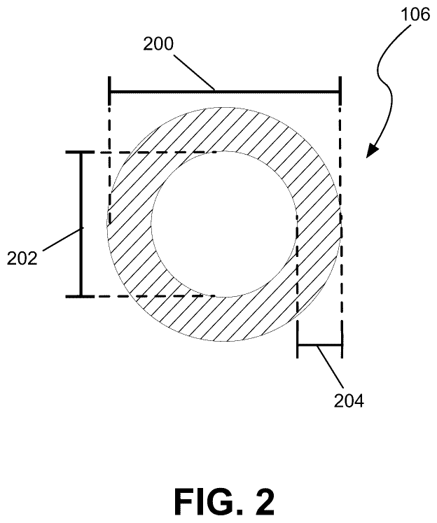

FIG. 2 is a cross-sectional view of delivery tubing 106 consistent with implementations described herein. As shown in FIG. 2, for suitability in driving or pushing probe shaft 104 and probe head 102, delivery tubing 106 may have an outside diameter 200 of not more than 0.50 inches and preferably less than or equal to 0.40 inches. UHMW delivery tubing 106 may have an inside diameter 202 of approximately 0.250 inches. Such dimensions result in a wall thickness 204 of delivery tubing 106 of approximately 0.050 to 0.250 inches and preferably a wall thickness of approximately 0.150 inches. Such a configuration provides sufficient strength and flexibility to push probe head 102 into a convoluted conduit under test. In addition, a length of delivery tubing 106 may be up to 150 feet long. As such, using a UHMW material as described above enables easier movement within a tube under test, including a convoluted, lengthy, and/or damaged conduit.

The foregoing description of exemplary implementations provides illustration and description but is not intended to be exhaustive or to limit the embodiments described herein to the precise form disclosed. Modifications and variations are possible in light of the above teachings or may be acquired from practice of the embodiments. For example, variations to the dimensions of delivery tubing 106 may be made without departing from the improvements described herein.

Although the invention has been described in detail above, it is expressly understood that it will be apparent to persons skilled in the relevant art that the invention may be modified without departing from the spirit of the invention. Various changes of form, design, or arrangement may be made to the invention without departing from the spirit and scope of the invention. Therefore, the above-mentioned description is to be considered exemplary, rather than limiting, and the true scope of the invention is that defined in the following claims.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

What is claimed is:

1. An eddy current probe system, comprising:
a probe head; and
delivery tubing coupled to the probe head for pushing or pulling the probe head into or out of a conduit under test,
wherein the delivery tubing comprises an ultra high molecular weight (UHMW) polyethylene material sufficient to enable insertion of the probe head into a convoluted, lengthy, or damaged conduit under test.

2. The eddy current probe system of claim 1, wherein the UHMW delivery tubing has an outside diameter of a not more than 0.50 inches and an inside diameter of not more than 0.250 inches.

3. The eddy current probe system of claim 1, wherein the UHMW delivery tubing has an outside diameter of 0.40 inches and an inside diameter of 0.250 inches.

4. The eddy current probe system of claim 1, wherein the UHMW delivery tubing has a wall thickness of between 0.050 to 0.250 inches.

5. The eddy current probe system of claim 1, wherein the UHMW delivery tubing has a wall thickness of approximately 0.150 inches.

6. The eddy current probe system of claim 1, wherein a length of the UHMW delivery tubing is up to 150 feet.

7. The eddy current probe system of claim 1, further comprising:
a conduit pushing device,
wherein the delivery tubing is forcibly pushed or withdrawn from the conduit under test by the conduit pushing device.

8. The eddy current probe system of claim 7, wherein the conduit pushing device comprises a pneumatic or motorized conduit pushing device.

9. The eddy current probe system of claim 1, wherein the probe head comprises:
a probe body that includes at least one eddy current generating coil; and
one or more centering members for ensuring that probe body is centered within the conduit under test.

10. The eddy current probe system of claim 9,
wherein each centering member comprises:
a tubular or frustoconical base portion; and
a plurality of resilient cantilevered legs that project radially and distally outwardly from the tubular or frustoconical base portion.

11. The eddy current probe system of claim 9, further comprising:
a probe shaft,
wherein the probe head and the delivery tubing are coupled to the probe shaft.

12. The eddy current probe system of claim 11, wherein the probe shaft comprises:
an extended flexible drive section; and
a rigid section,
wherein the probe head is coupled to the rigid section.

13. The eddy current probe system of claim 11, further comprising:
a plurality of centering beads coupled to the probe shaft for ensuring that probe shaft is centered within the conduit under test.

14. Delivery tubing for a conduit testing system, comprising:
an ultra high molecular weight (UHMW) polyethylene material sufficient to enable insertion of the probe head into a convoluted, lengthy, or damaged conduit under test,
wherein the UHMW delivery tubing comprises an outside diameter of a not more than 0.50 inches and an inside diameter of not more than 0.250 inches,
wherein the UHMW delivery tubing comprises a wall thickness of between 0.050 to 0.250 inches.

15. The delivery tubing of claim 14, comprising a wall thickness of 0.150 inches.

16. The delivery tubing of claim 15, comprising a length up to 150 feet.

17. The delivery tubing of claim 14,
wherein the UHMW material comprises a low coefficient of friction and high abrasion resistance relative to traditional nylon delivery tubing, which allows for reduced force requirements when pushing a testing probe into a conduit under test.

18. A conduit testing system, comprising:
a testing probe;
one or more centering members for engaging a conduit under test and maintaining the testing probe centered therein and; and
delivery tubing coupled to the testing probe head for pushing or pulling the probe head into or out of the conduit under test,
wherein the delivery tubing comprises an ultra high molecular weight (UHMW) polyethylene material sufficient to enable insertion of the probe head into a convoluted, lengthy, or damaged conduit under test,
wherein the delivery tubing comprises an outside diameter less than 0.40 inches and a wall thickness of between 0.10 to 0.25 inches.

19. The conduit testing system of claim 18, wherein the wall thickness comprises 0.150 inches.

20. The conduit testing system of claim 18, wherein the delivery tubing comprises a length of up to 150 feet.
